(19) United States
(12) Patent Application Publication
(10) Pub. No.: US 2006/0176182 A1
(43) Pub. Date: Aug. 10, 2006

(54) Monitor electronic apparatus system, monitor method, program and recording medium

(76) Inventors: Eiji Noguchi, Osaka (JP); Hiroshi Yamamoto, Osaka (JP)

Correspondence Address: RATNERPRESTIA, P.O. BOX 980, VALLEY FORGE, PA, 19482, US

(21) Appl. No.: 10/546,222

(22) PCT Filed: Feb. 18, 2004
(86) PCT No.: PCT/JP04/01779

§ 371 Date: Aug. 18, 2005

(30) Foreign Application Priority Data
Feb. 19, 2003 (JP) 2003-041660

(51) Int. Cl. G08B 23/00

(52) U.S. Cl. 340/573.1

(57) ABSTRACT

An electronic apparatus system or monitoring health, security or safety includes a pet-type robot; human detecting device detecting that a person is within a predetermined circumference of an electronic apparatus, such as a robot, and outputting the signal; access detecting device detecting access to the electronic apparatus; and access history storing device storing the output from the access detecting means. The electronic apparatus system also includes parameter storing device storing a parameter serving as a reference; and judging device making a judgment on health, security or safety by comparing all or part of access histories obtained after the determination of the parameter with the parameter in the case that the person is detected within the predetermined circumference of the electronic apparatus, or not making the judgment where the person is not detected within the predetermined circumference of the electronic apparatus, such as the robot.

### TECHNICAL FIELD

The present invention relates to an electronic apparatus system and the like of monitoring health, security or safety.

### BACKGROUND ART

Conventionally, in apartments and other independent houses, a home safety/security control system of concentratedly controlling fire alarms, crime-prevention alarms, gas-leak alarms, sound-generation alarms, etc. has been put into practical use. In this security monitoring system, dangerous states are detected by various sensors in various places in a home, and the information is transmitted to the outside. For example, a gas-leak alarm sensor is provided in the vicinity of a gas pipe line to detect gas leakage, and a sound-generation alarm is provided on a window to detect an intruder coming from the outside.

On the other hand, a mobile monitoring apparatus incorporates various sensors in the mobile monitoring apparatus itself, wherein each sensor detects abnormality and the information is transmitted to the outside using wireless communication or the like, and confirming security and detecting and intimidating suspicious individuals are carried out as main functions thereof (refer to Japanese Patent Application Laid-Open No. H05-300950, for example).

However, in the case that a solitary old person is assumed to be monitored, usage of ensuring security against intrusion from the outside is certainly necessary; however, it is conceivable that there is a stronger demand for monitoring health, security or safety in the case that such an old person is sick in bed and cannot get in contact, for example, as a problem of old people.

Hence, some solitary old people or some self-governing bodies install apparatuses, such as an emergency button and a monitoring camera, however, many users say that they do not want to install such, since in the case of being really critical, they cannot press the emergency button because the body becomes less responsive, in the case of being just slightly poor in physical condition, they hesitate to press the emergency button, and they have a sense that the inside of the home is monitored by a monitoring camera.

Hence, the apparatus has a problem of being insufficient in function as a system of monitoring health, security or safety in the case that a solitary old person or the like is monitored.

Although a system of monitoring an old person or the like, developed by paying attention to the operation to an electric pot and disclosed in Japanese Patent Application Laid-Open No. 2002-78034, is known, the system is not satisfactory since attention is paid to only the operation.

### DISCLOSURE OF THE INVENTION

In consideration of the conventional problems described above, the present invention is intended to provide a monitoring electronic apparatus system and the like capable of monitoring health, security or safety without giving a sense of being monitored, including a slight change in health condition, such as a slightly poor physical condition.

The 1^{st} aspect of the present invention is a monitoring electronic apparatus system comprising:

an electronic apparatus body,

human detecting means of detecting that a person is within a predetermined circumference of said electronic apparatus body and outputting the signal,

access detecting means of detecting access to said electronic apparatus body,

access history storing means of storing an output from said access detecting means,

parameter storing means of storing a parameter that is determined on the basis of said access histories and serves as a reference required for monitoring health, security or safety, and

judging means of making a judgment on health, security or safety by comparing all or part of access histories obtained from said access history storing means after time of the determination of said parameter, with said parameter obtained from said parameter storing means in a case that the person is detected by said human detecting means within the predetermined circumference of said electronic apparatus body, or not making a judgment on health, security or safety in a case that the person is not detected within the predetermined circumference of said electronic apparatus body.

The 2^{nd} aspect of the present invention is a monitoring electronic apparatus system according to the 1^{st} aspect of the present invention, wherein said access includes at least a number of times of human detections by said human detecting means or another human detecting means and operations to said electronic apparatus body.

The 3^{rd} aspect of the present invention is a monitoring electronic apparatus system according to the 1^{st} aspect of the present invention, wherein

said parameter is a parameter determined by a sum of the number of times of human detections and the number of times of operations to said electronic apparatus body in said access histories, and

said judging means is judging means of making a judgment on health, security or safety by comparing the sum of the number of times of human detections and the number of times of operations to said electronic apparatus body in all or part of access histories obtained from said access history storing means after the time of the determination of said parameter, with said parameter.

The 4^{th} aspect of the present invention is a monitoring electronic apparatus system according to the 1^{st} aspect of the present invention, wherein

said parameter is a parameter determined by the ratio of the number of times of operations to said electronic apparatus body to the number of times of human detections in said access histories,

said judging means is judging means of making a judgment on health, security or safety by comparing the ratio of the number of times of operations to said electronic apparatus body to the number of times of human detections in all or part of access histories obtained from said access history storing means after the time of the determination of said parameter, with said parameter.

The 5^{th} aspect of the present invention is a monitoring electronic apparatus system according to the 2^{nd} aspect of the present invention, wherein said number of times of human detections is the number of times of detections at every predetermined time.

The 6^{th} aspect of the present invention is a monitoring electronic apparatus system according to the 2^{nd} aspect of the present invention, wherein said number of times of human detections is the number of times of comings-and-goings within a predetermined circumference of said electronic apparatus body.

The 7^{th} aspect of the present invention is a monitoring electronic apparatus system according to the 2^{nd} aspect of the present invention, wherein duration time from time of coming in the predetermined circumference of said electronic apparatus body to time of going out therefrom is instead of said number of times of detections at every predetermined time.

The 8^{th} aspect of the present invention is a monitoring electronic apparatus system according to the 1^{st} aspect of the present invention, further comprising judgment confirming means of making a confirmation of health, security or safety by recognizing an operation done by the person to said electronic apparatus body in response to a call from said electronic apparatus body to the person in a case that a judgment stating that the person is not healthy or secure is output by said judging means.

The 9^{th} aspect of the present invention is a monitoring electronic apparatus system according to the 1^{st} aspect of the present invention, further comprising:

human detection confirming means of detecting a person in a case that a judgment stating that the person is not healthy or secure is output by said judging means, and

judgment confirming means of confirming health, security or safety on the basis of duration time during which the person is detected by said human detection confirming means.

The 10^{th} aspect of the present invention is a monitoring electronic apparatus system according to the 1^{st} aspect of the present invention, wherein said human detecting means is a sensor of detecting whether the person is in a house provided with said electronic apparatus body, more particularly, a current collecting sensor installed at an entrance and/or a window thereof.

The 11^{th} aspect of the present invention is a monitoring electronic apparatus system according to the 1^{st} aspect of the present invention, wherein said human detecting means is a current collecting sensor installed in said electronic apparatus body.

The 12^{th} aspect of the present invention is a monitoring electronic apparatus system according to the 1^{st} aspect of the present invention, further comprising image recognizing means capable of recognizing the expression of the person, wherein said judging means is judging means of judging whether the person is healthy or secure on the basis of image data information obtained from said image recognizing means.

The 13^{th} aspect of the present invention is a monitoring electronic apparatus system according to the 1^{st} aspect of the present invention, further comprising voice recognizing means capable of recognizing the voice of the person, wherein said judging means is judging means of judging whether the person is healthy or secure on the basis of voice data information obtained from said voice recognizing means.

The 14^{th} aspect of the present invention is a monitoring electronic apparatus system according to the 1^{st} aspect of the present invention being a pet-type robot.

The 15^{th} aspect of the present invention is a monitoring method comprising:

a human detecting step of detecting that a person is within a predetermined circumference of an electronic apparatus body and outputting the signal,

an access detecting step of detecting access to said electronic apparatus body,

an access history storing step of storing an output from said access detecting step,

a parameter storing step of storing a parameter that is determined on the basis of said access histories and serves as a reference required for monitoring health, security or safety, and

a judging step of making a judgment on health, security or safety by comparing all or part of access histories obtained from said access history storing step after time of the determination of said parameter, with said parameter obtained from said parameter storing step in a case that the person is detected by said human detecting step within the predetermined circumference of said electronic apparatus body, or not making a judgment on health, security or safety in a case that the person is not detected within the predetermined circumference of said electronic apparatus body.

The 16^{th} aspect of the present invention is a program of operating a computer to function as:

access history storing means of storing an output from said access detecting means,

parameter storing means of storing a parameter that is determined on the basis of said access histories and serves as a reference required for monitoring health, security or safety, and

judging means of making a judgment on health, security or safety by comparing all or part of access histories obtained from said access history storing means after time of the determination of said parameter, with said parameter obtained from said parameter storing means in a case that the person is detected by said human detecting means within the predetermined circumference of said electronic apparatus body, or not making a judgment on health, security or safety in a case that the person is not detected within the predetermined circumference of said electronic apparatus body in a monitoring electronic apparatus system according to the 1^{st} aspect of the present invention.

The 17^{th} aspect of the present invention is a recording medium having said program according to the 16^{th} aspect of the present invention and being usable by a computer.

### BEST MODES FOR CARRYING OUT THE INVENTION

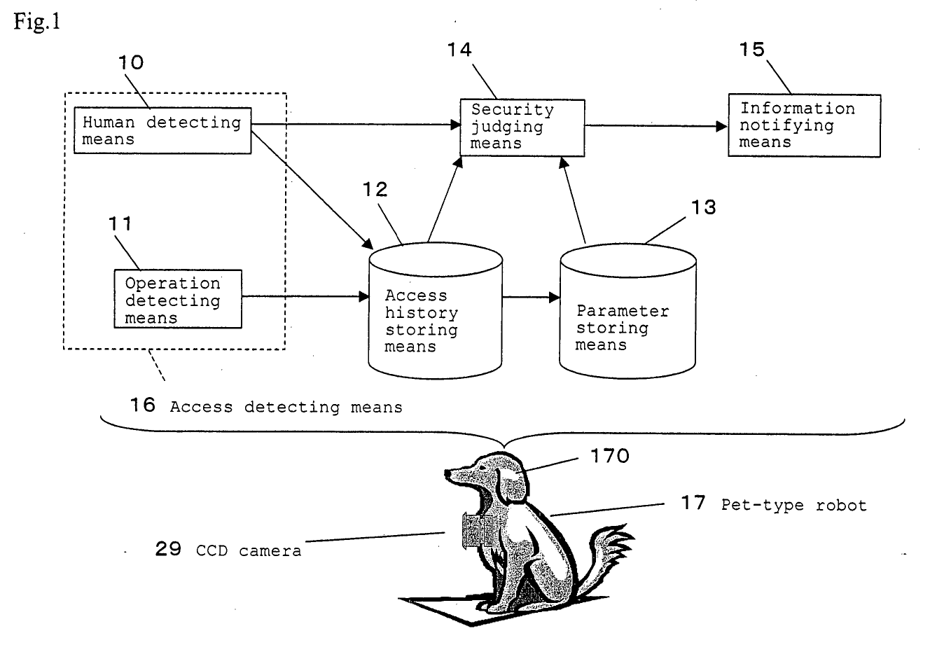

FIG. 1 is a block diagram regarding an electronic apparatus system of monitoring health, security or safety in accordance with Embodiment 1 of the present invention;

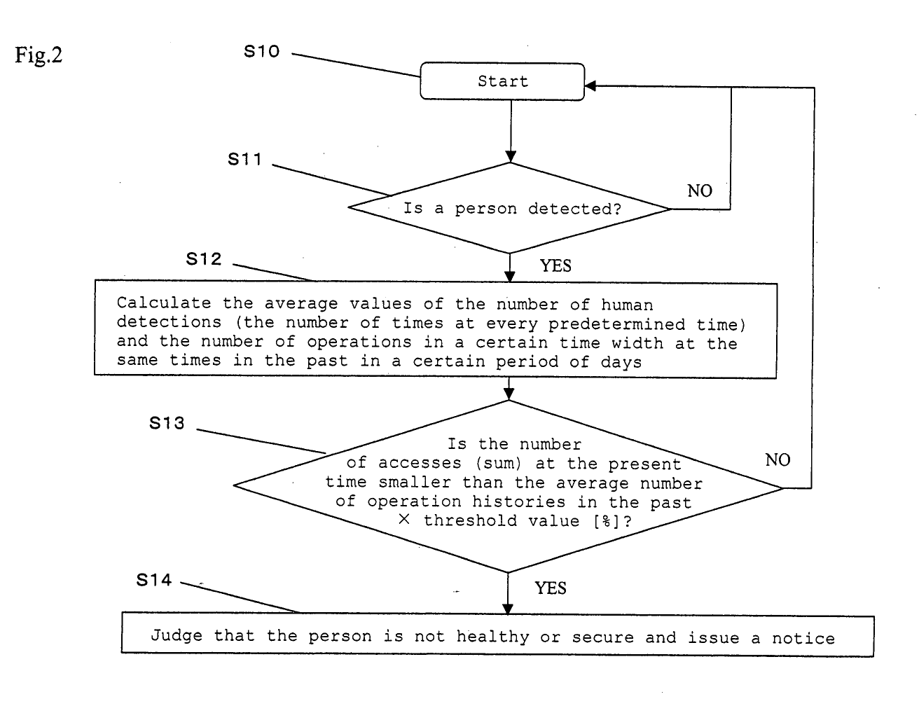

FIG. 2 is a flowchart regarding the judgment algorithm of the electronic apparatus system of monitoring health, security or safety in accordance with Embodiment 1 of the present invention;

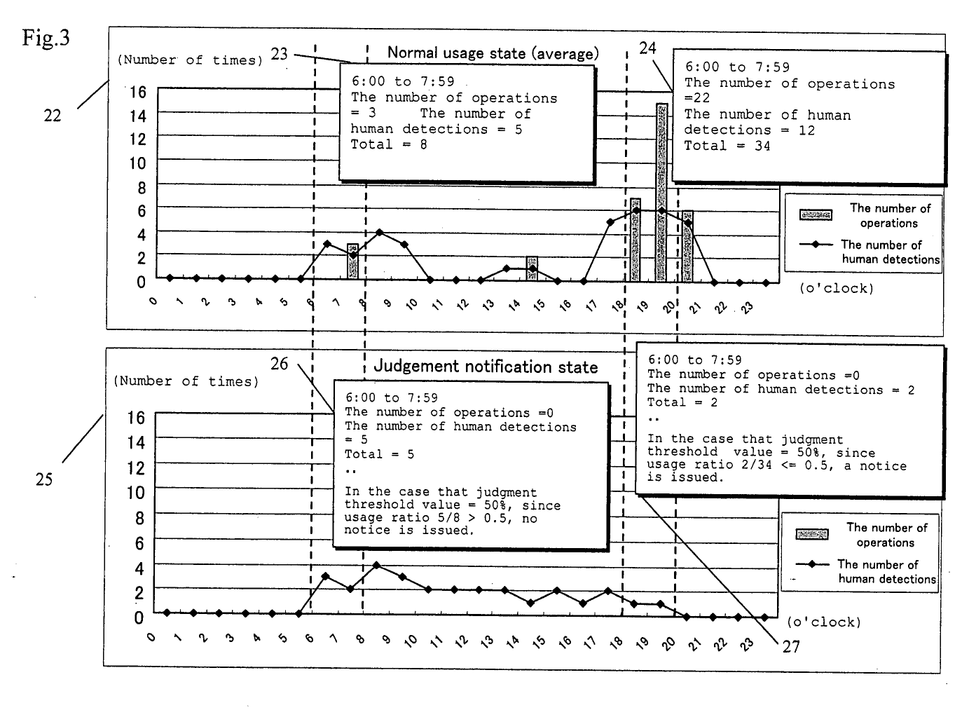

FIG. 3 is a graph showing data obtained by carrying out the health monitoring judgment algorithm of the electronic apparatus system of monitoring security in accordance with Embodiment 1 of the present invention;

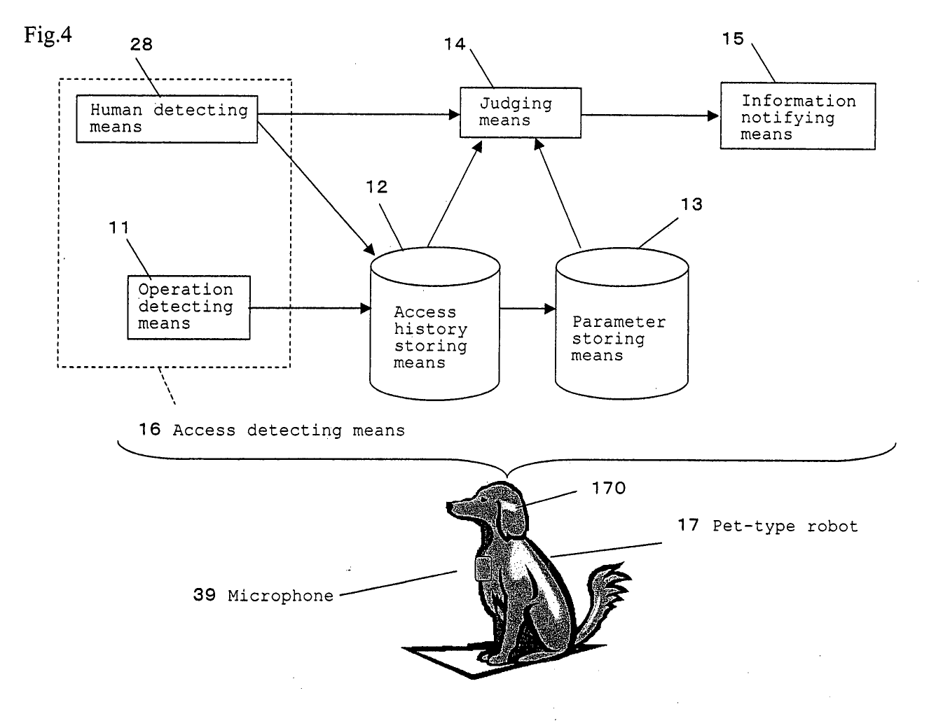

FIG. 4 is a block diagram regarding an electronic apparatus system of monitoring health, security or safety in accordance with Embodiment 2 of the present invention;

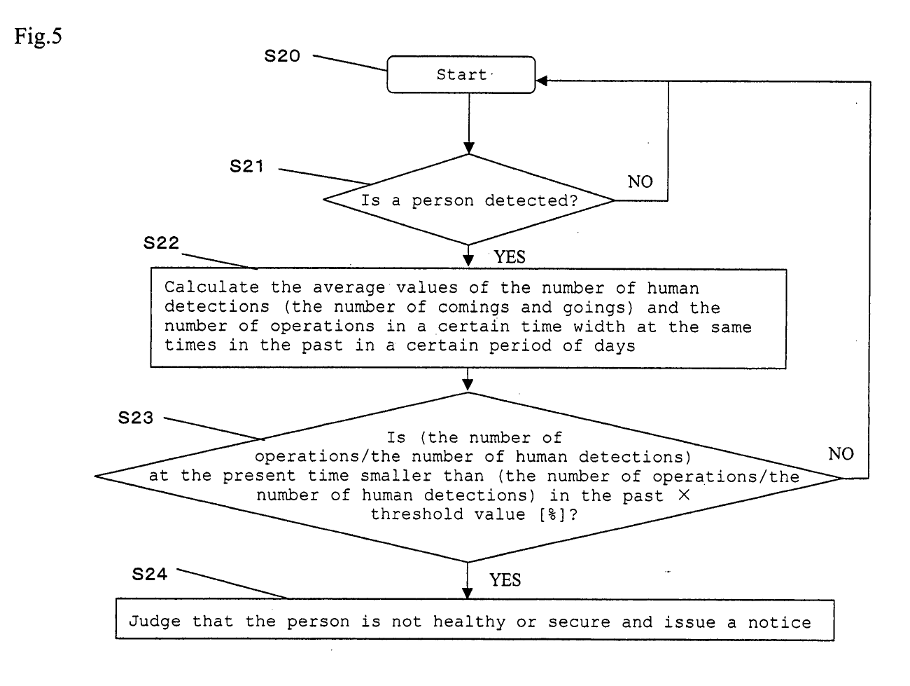

FIG. 5 is a flowchart regarding the judgment algorithm of the electronic apparatus system of monitoring health, security or safety in accordance with Embodiment 2 of the present invention;

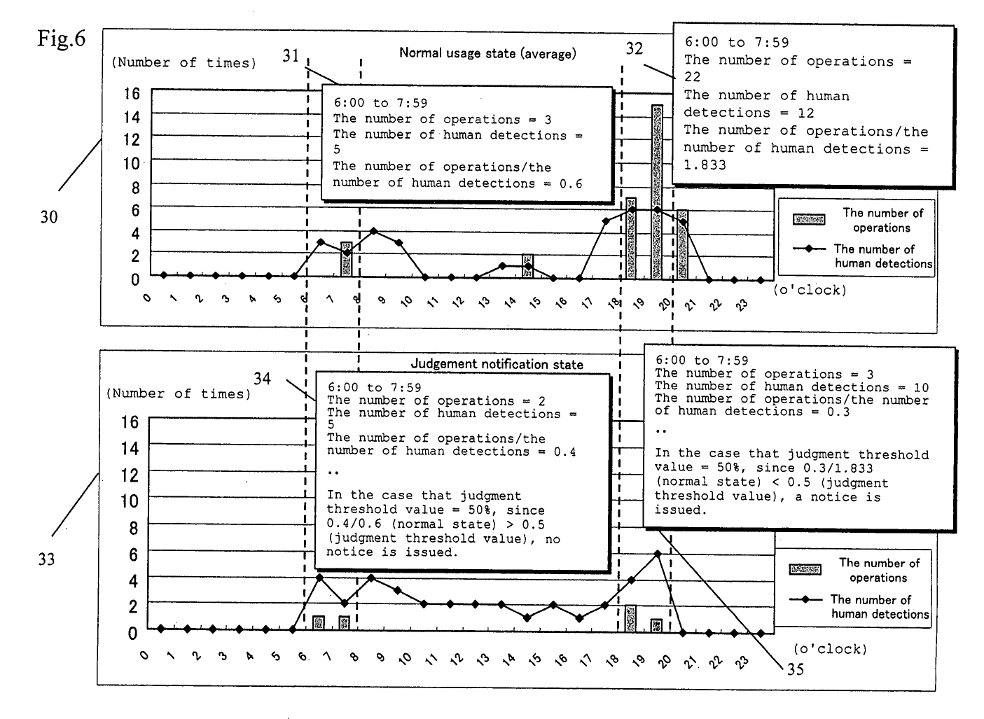

FIG. 6 is a graph showing data obtained by carrying out the judgment algorithm of the electronic apparatus system of monitoring health, security or safety in accordance with Embodiment 2 of the present invention;

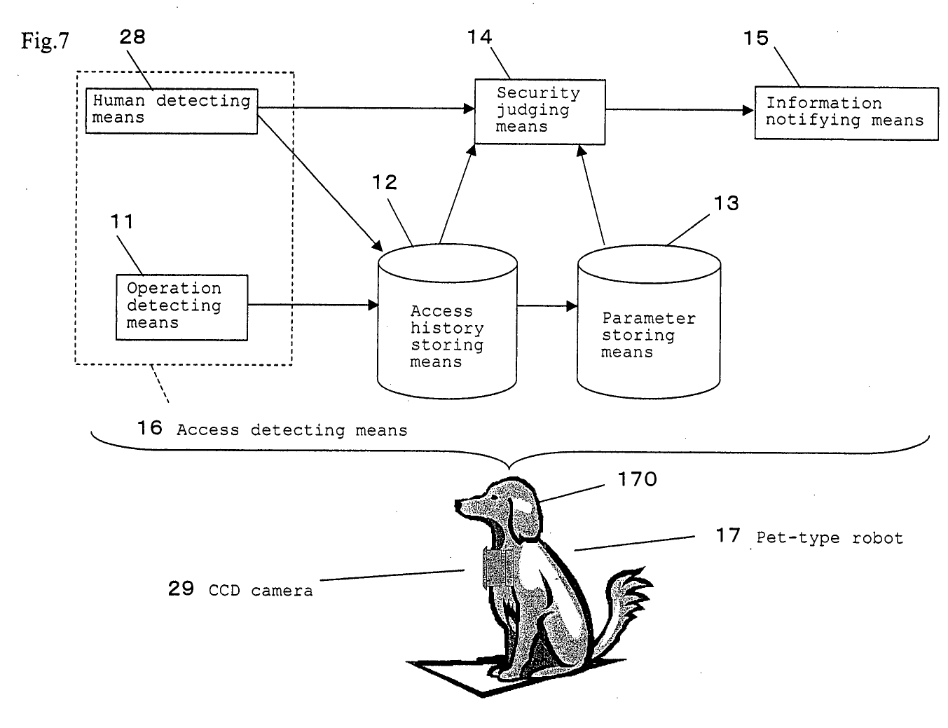

FIG. 7 is a block diagram regarding a monitoring electronic apparatus system in accordance with Embodiment 3 of the present invention;

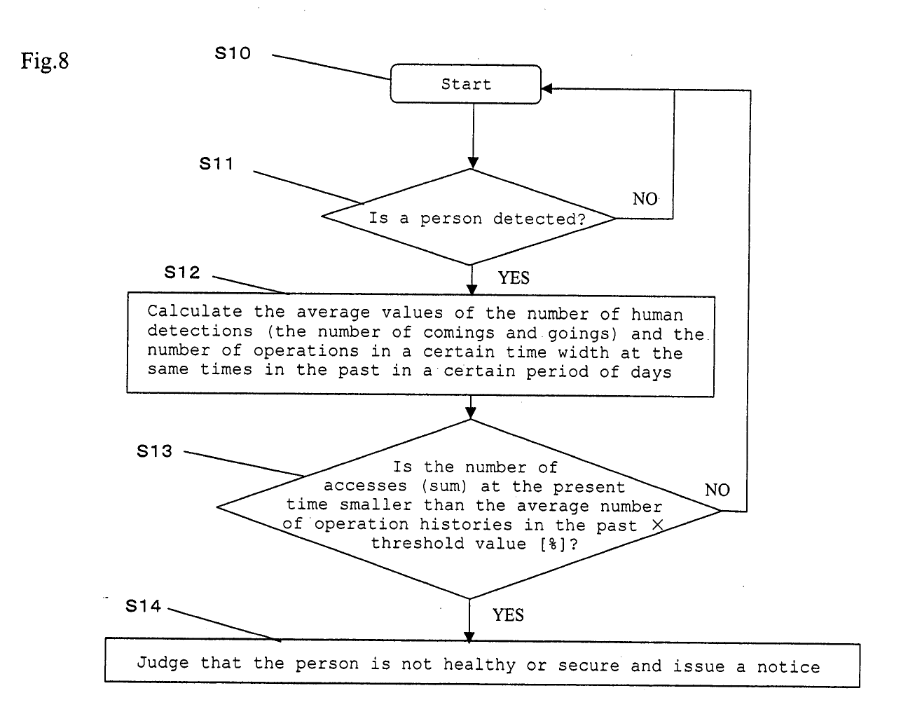

FIG. 8 is a flowchart regarding the judgment algorithm of the monitoring electronic apparatus system in accordance with Embodiment 3 of the present invention;

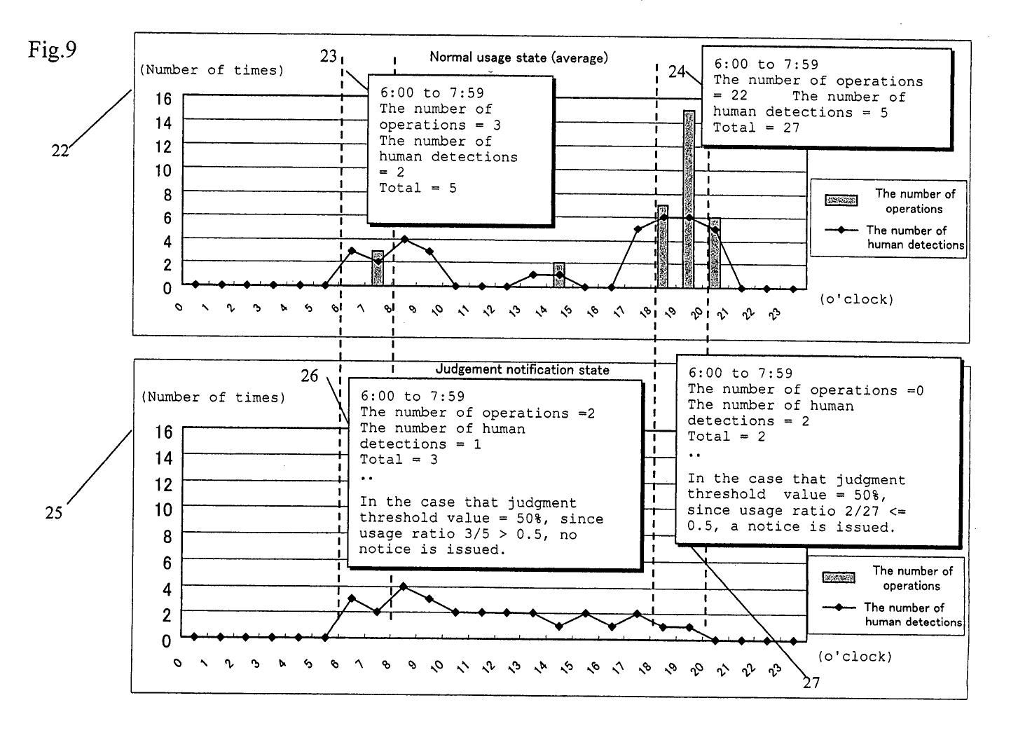

FIG. 9 is a graph showing data obtained by carrying out the health monitoring judgment algorithm of the electronic apparatus system of monitoring security in accordance with Embodiment 3 of the present invention;

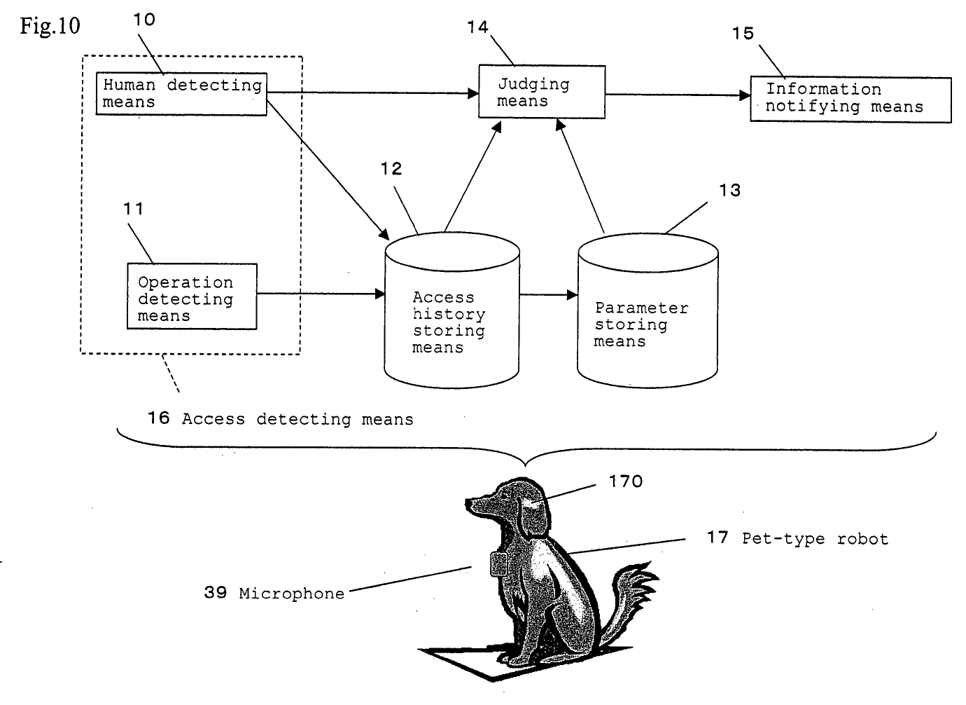

FIG. 10 is a block diagram regarding a monitoring electronic apparatus system in accordance with Embodiment 4 of the present invention;

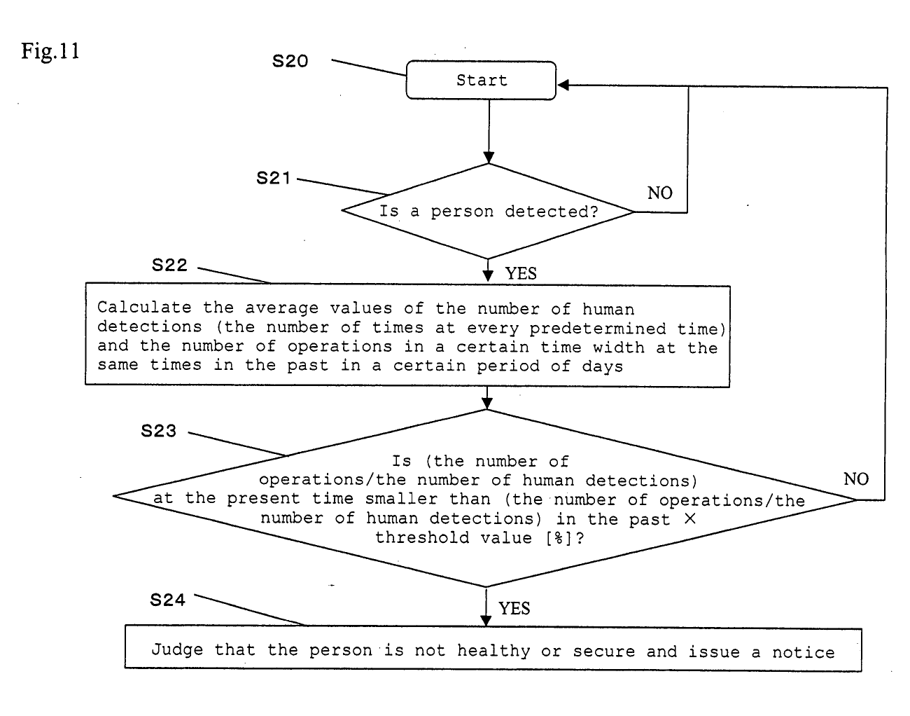

FIG. 11 is a flowchart regarding the judgment algorithm of the monitoring electronic apparatus system in accordance with Embodiment 4 of the present invention;

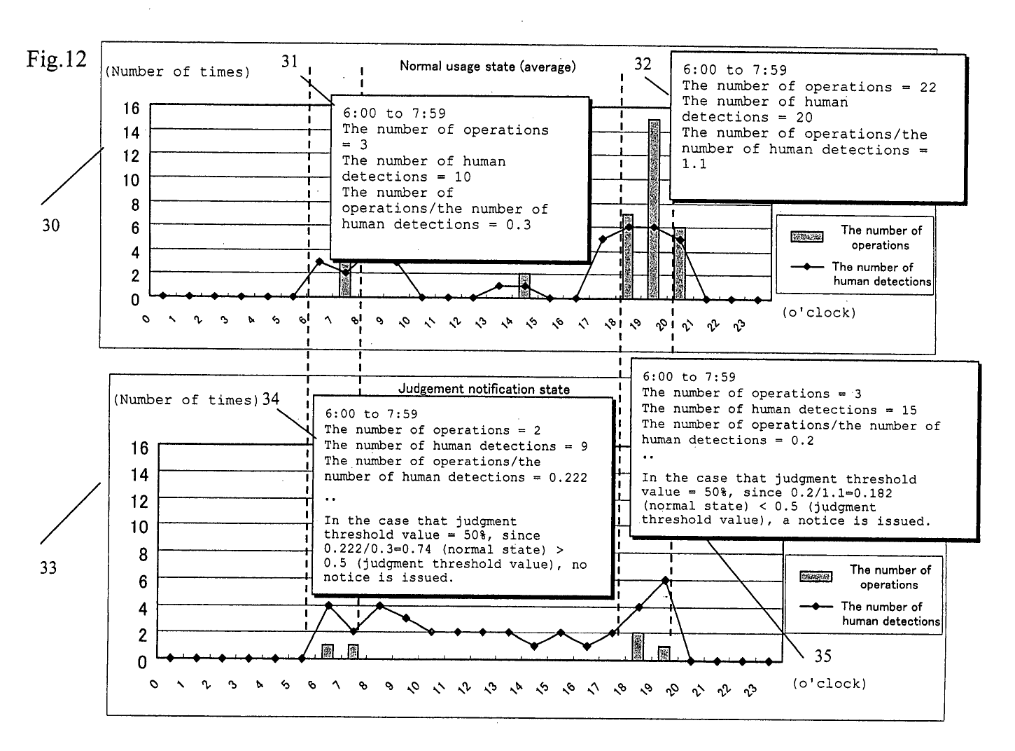

FIG. 12 is a graph showing data obtained by carrying out the judgment algorithm of the monitoring electronic apparatus system in accordance with Embodiment 4 of the present invention;

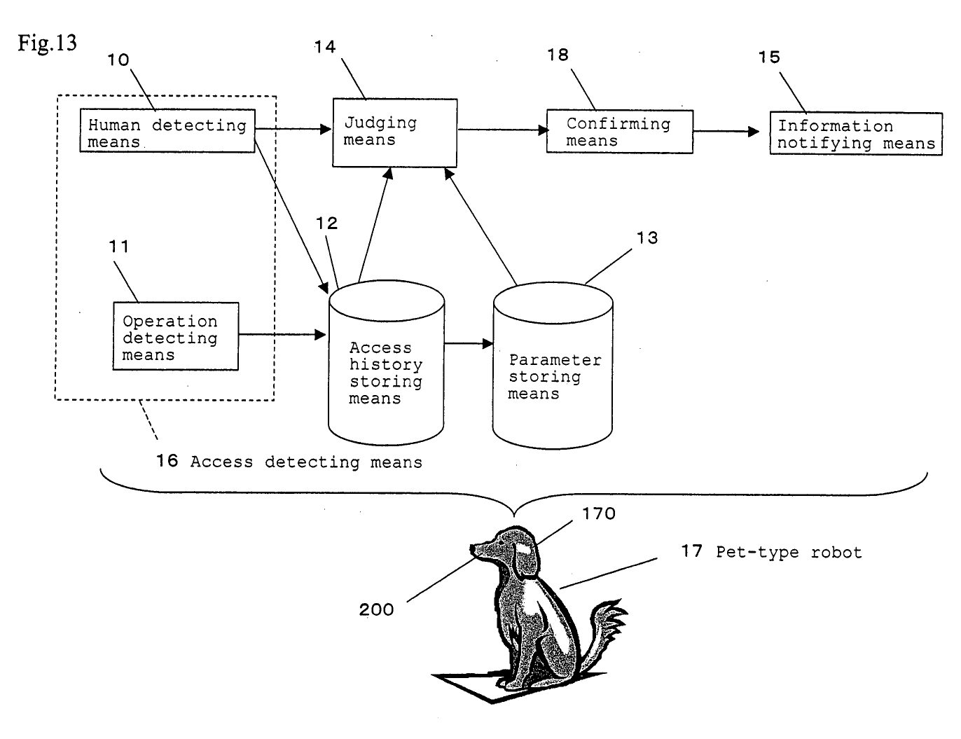

FIG. 13 is a block diagram regarding a monitoring electronic apparatus system in accordance with Embodiment 3 of the present invention;

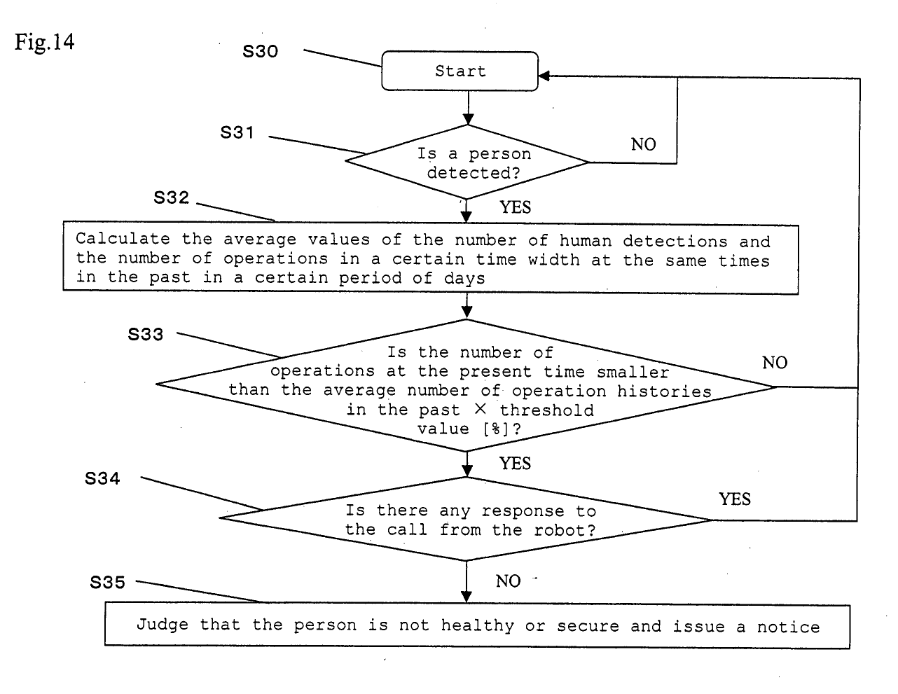

FIG. 14 is a flowchart regarding the judgment algorithm of the monitoring electronic apparatus system in accordance with Embodiment 3 of the present invention;

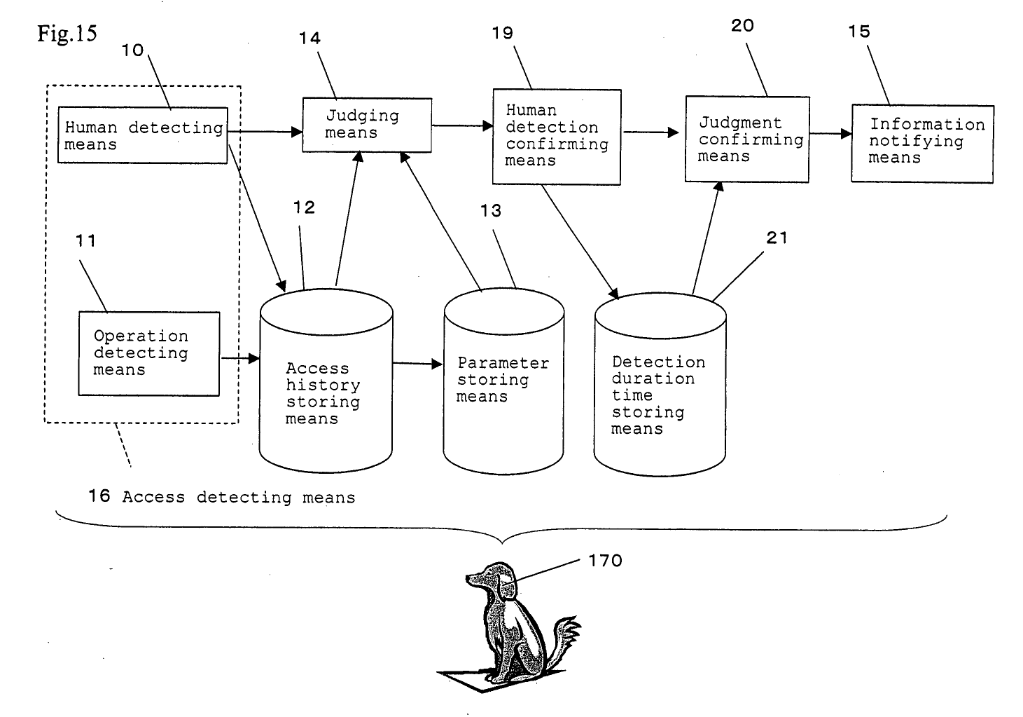

FIG. 15 is a block diagram regarding a monitoring electronic apparatus system in accordance with Embodiment 4 of the present invention; and

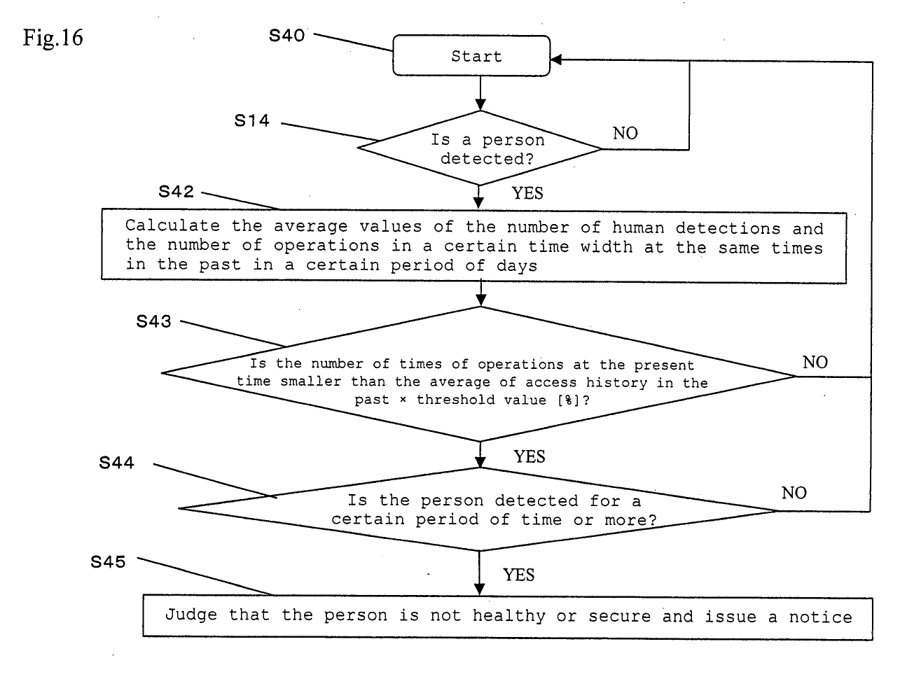

FIG. 16 is a flowchart regarding the judgment algorithm of the monitoring electronic apparatus system in accordance with Embodiment 4 of the present invention.

### EXPLANATIONS OF NUMERALS

10 human detecting means
11 operation detecting means
12 access history storing means
13 parameter storing means
14 judging means
15 information notifying means
16 access detecting means
17 pet-type robot
170 pet-type robot body

### BEST MODES FOR CARRYING OUT THE INVENTION

Embodiments in accordance with the present invention will be described below referring to the drawings.

### Embodiment 1

FIG. 1 is a view showing a pet-type robot 17 serving as an example of a monitoring electronic apparatus system in accordance with Embodiment 1 and a functional block diagram of the pet-type robot 17. The pet-type robot 17 in accordance with Embodiment 1 has a human detecting means 10, formed of a current collecting sensor, capable of detecting infrared light emitted from a person in front of the robot body 170 and outputting the detection information.

In Embodiment 1, the human detecting means 10 is a human detecting means of carrying out human detection at every predetermined time. For this reason, when human detection is carried out once at every minute, for example, a person sitting in front of the robot body 170 for 10 minutes is detected 10 times. In addition, the robot body 170 has an operation detecting means 11 of measuring operations to itself, such as operations regarding voice interaction, the results of voice recognition, speech voice recording, switch operation, power on/off information and actions and of converting these to logs. The human detecting means 10 and the operation detecting means 11 constitute an access detecting means 16 in accordance with the present invention.

Furthermore, an access history storing means 12 is provided which is capable of storing the output from the access detecting means 16 comprising the operation detecting means 11 and the human detecting means 10 in a recording medium, such as a hard disk, a memory or a tape, and capable of reading the access histories as necessary. Moreover, a parameter storing means 13 is provided which is capable of storing a parameter required for making a judgment on health or security in a recording medium, such as a hard disk, a memory or a tape, and capable of reading the access histories as necessary. In Embodiment 1, the degree of access is judged by the sum of the number of times of human detections and the number of times of operations.

Moreover, a judging means 14 is provided which confirms the existence of a person by watching the output of the human detecting means 10, evaluates the access histories remaining in the access history storing means 12 for a certain period on the basis of the confirmation, and makes a judgment on health or security by using the parameter value stored in the parameter storing means 13 as a criterion.

Still further, the judging means 14 is provided with an information notifying means 15 of notifying the result of the judgment to a regional welfare center, family members outside the house, a security company, etc. using communication means, such as telephone lines, electronic mail or wireless communication.

The operation of the monitoring electronic apparatus system configured as described above will be described below. First, the number of times a person to be monitored for health, security or safety has been detected by the human detecting means 10 of the pet-type robot body 170 and the number of times of operations carried out by the person to the pet-type robot body 170 and detected by the operation detecting means 11 are stored sequentially in the access history storing means 12. This access history data is data in a normal state at the time when the person to be monitored is healthy or secure.

Next, the pet-type robot 17 in accordance with Embodiment 1 judges whether the user is healthy or secure by carrying out processing comprising judgment steps shown in FIG. 2. Start symbol S10 represents the start of the judgment, and the processing starts referring to the histories of the user.

Next, even if the user does not access the robot body 170, there is a possibility that no operation is made because the user is out and is not at home; hence, a judgment as to whether a person is present in front of the pet-type robot body 170 is made at human detection judgment step S11 using the human detecting means 10; only in the case that the person is present, a judgment on health or security is made.

Then, in the case that the person is present in front of the pet-type robot body 170, the access histories of the access history storing means 12 are delivered from the parameter storing means 13, and the average values in a certain period (number of days, time width) are calculated at history calculation step S12. FIG. 3 shows an example of access history data. A graph 22 is a graph showing the number of times of human detections and the number of times of past operations in a normal usage state (average) with respect to time. The number of times of human detections is represented by a line graph, and the number of times of past operations is represented by a bar graph. As a parameter, assuming that consideration is given to histories of the past three days, the data in the past three days is accessed, and the average values in the three days are graphed. In addition, it is assumed that the parameter of time resolution (time width) for the judgment is two hours and that the threshold value for the judgment on health or security is 50%.

Attention is paid to average usage state 23 in the period from 6:00 to 7:59 and average usage state 24 in the period from 18:00 to 19:59 in the data in the past three days. In the period from 6:00 to 7:59, the average number of times of human detections is five and the average number of times of operations is three. Hence, the number of times of accesses is eight. Furthermore, the average number of times of human detections is 12 and the average number of times of operations is 22 according to average usage state 24 in the period from 18:00 to 19:59. Hence, the number of times of accesses is 34.

Next, at threshold judgment step S13, the number of times of accesses (the sum of the number of times of human detections and the number of times of operations) used at the present time is compared with the average number of times of accesses (the sum of the number of times of human detections and the number of times of operations) obtained at history calculation step S12 for two hours in the past three days using the judging means 14 in the same time resolution of two hours. Herein, the number of times of human detections is five and the number of times of operations is zero in usage state 26 in the period from 6:00 to 7:59 in the graph 25 of a judgment notification state. Hence, the number of times of accesses is five. Furthermore, the number of times of human detections is two and the number of times of operations is zero in usage state 27 in the period from time 18:00 to time 19:59 in the graph 25 of the judgment notification state. Hence, the number of times of accesses is two.

Thus, (the average number of times of human detections+the average number of times of operations in the past three days) is calculated and compared with the calculated value of (the number of times of human detections+the number of times of operations) of the graph 25 of the security judgment notification state. As described above, the value in the case of the period from 6:00 to 7:59 in the past three days is eight times, and the value in the judgment notification state is five times. Hence, since the usage (5/8>0.5) larger than the threshold value of 50% serving as a parameter is done, it is judged that the person is healthy or secure, and no notice is issued.

Furthermore, in the case of the period from 18:00 to 19:59, (the average number of times of human detections+the average number of times of operations in the past three days) is 34, and the value in the judgment notification state is two times. Herein, since the usage (2/34<0.5) larger than the threshold value of 50% serving as a parameter is not done, it is judged that a condition of being harmful to health or not secure has occurred for some reason.

In the end, at notification step S14, the result of the judgment can be notified by the information notifying means 15 to family members and relatives outside the house, a regional welfare center, a security company, etc. using means, such as voice, electronic mail, telephone or wireless communication.

As described above, in Embodiment 1, on the basis of the parameter storing means 13, the output of the human detecting means 10 and the histories of the access history storing means 12 are judged comprehensively. In other words, in the case that the user usually operating the robot body 170 stops the operation abruptly one day although the user has come to the circumference of the robot body 170, there is a possibility that some trouble has occurred in the body of the user. Furthermore, in the case that the user habitually operating the robot body 170 in a predetermined time zone carries out the operation on less occasions abruptly one day although the user has come to the circumference of the robot body 170, it is conceivable that some condition being hazardous to health or security has occurred. In the case that the user is not healthy or secure, a notice is issued to the outside, whereby the monitoring of health, security or safety can be carried out.

It may be possible that the number of times of human detections and the number of times of operations are respectively weighted and that the sum of the weighted values is used as the number of times of accesses, that is, the degree of access.

Furthermore, in Embodiment 1, the human detecting means 10 is used to detect whether a person is within a predetermined range around the robot body 170 and is also used to detect access; however, a human detection sensor may be provided separately to detect access.

### Embodiment 2

FIG. 4 is a block diagram of a monitoring system in accordance with Embodiment 2. Although the monitoring system in accordance with Embodiment 2 is the same as Embodiment 1 in configuration, it is different in health judgment and human detection methods; hence, the different points will be described mainly. The same components as those of Embodiment 1 are designated by the same numerals.

A human detecting means in accordance with Embodiment 2 is different from that of Embodiment 1; a human detecting means 28 carries out human detection at all times using a current collecting sensor to detect the comings-and-goings of a person. For example, even if a person keeps sitting for 10 minutes in front of the pet-type robot body 170, the number of times of human detections is one. Unlike the case of Embodiment 1, the degree of access in Embodiment 2 is evaluated according to the ratio between the number of times of human detections and the number of times of operations.

The operation of the monitoring electronic apparatus system having the above-mentioned configuration will be described below.

In Embodiment 2, as a judgment on health, security or safety, processing comprising judgment steps shown in FIG. 5 is carried out to judge whether the user is healthy or secure. Start symbol S20 represents the start of the judgment processing, and the processing starts referring to the histories of the user.

Next, even if the user does not operate the robot body 170, there is a possibility that no operation is made because the user is out and is not at home; hence, a judgment as to whether a person is in the room is made at human detection judgment step S21; only in the case that the person is in the room, a judgment on health or security is made.

Then, in the case that the person is in the room, the access histories stored in the access history storing means 12 is delivered from the parameter storing means 13, and the average values in a certain period (number of days, time width) are calculated at history calculation step S22. FIG. 6 shows an example of access history data. A graph 30 is a graph showing the number of times of human detections and the number of times of past operations in a normal usage state (average) with respect to time. The number of times of human detections is represented by a line graph, and the number of times of past operations is represented by a bar graph. As a parameter, assuming that consideration is given to histories in the past three days, the data in the past three days is accessed, and the average values in the three days are graphed. In addition, it is assumed that the parameter of time resolution (time width) for the judgment is two hours, and that the threshold value for the judgment on health or security is 50%.

Attention is paid to average usage state 31 in the period from 6:00 to 7:59 and average usage state 32 in the period from 18:00 to 19:59 in the graph 30 showing the average usage state. In the period from 6:00 to 7:59, the average number of times of human detections is five and the average number of times of operations is three. Hence, (the number of times of operations/the number of times of human detections) serving as the degree of access is 3/5=0.6. Furthermore, in the period from 18:00 to 19:59, the average number of times of human detections is 12 and the average number of times of operations is 22. Hence, (the number of times of operations/the number of times of human detections) serving as the degree of access is 12/22=1.833.

Next, at threshold judgment step S23, the ratio of the number of times of operations to the number of times of human detections used at the present time is compared with the ratio of the average number of times of operations to the average number of times of human detections in the past three days, obtained at history calculation step S22, in the same time resolution of two hours. Herein, the number of times of human detections is five and the number of times of operations is two in usage state 34 in the period from 6:00 to 7:59 in the graph 33 of a judgment notification state. Hence, (the number of times of operations/the number of times of human detections) serving as the degree of access is 2/5=0.4. Furthermore, the number of times of human detections is 10 and the number of times of operations is three in average usage state 35 in the period from 18:00 to 19:59 in the graph 33 of the judgment notification state. Hence, (the number of times of operations/the number of times of human detections) serving as the degree of access is 3/10=0.3.

In this way, (the average number of times of operations in the past three days/the average number of times of human detections in the past three days) is calculated and compared with the calculated value of (the number of times of operations/the number of times of human detections) of the graph 33 of the judgment notification state. As described above, the value is 0.3 in average usage state 31 in the period from 6:00 to 7:59, and the value in the judgment notification state is 0.4; hence, since the usage (0.6/0.4>0.5) larger than the threshold value of 50% serving as a parameter is done, it is judged that the person is healthy or secure, and no notice is issued.

Furthermore, as described above, in the case of the period from 18:00 to 19:59, (the average number of times of operations in the past three days/the average number of times of human detections in the past three days) ×the threshold value is 1.833, and the value of (the number of times of operations/the number of times of human detections) in the judgment notification state is 0.3. Herein, since the usage (0.3/1.83<0.5) larger than the threshold value of 50% serving as a parameter is not done, it is known that the number of times of operations is less than ever before although the person is detected in the circumference of the robot body 170. Hence, since the behavior of the person in the house is abnormal, it is judged that there is a possibility that the person, who is in the vicinity of the robot body 170, is sick or not secure, for example, the person has sprained his ankle and cannot move.

In the end, by the means at notification step S24, the result of the judgment can be notified to family members and relatives outside the house, a regional welfare center, a security company, etc. using means, such as voice, electronic mail, telephone or wireless communication.

### Embodiment 3

Although the monitoring system in accordance with Embodiment 3 is the same as Embodiment 1 in configuration, it is different in health judgment and human detection methods; hence, the different points will be described mainly.

As shown in FIG. 7, a human detecting means 28 in accordance with Embodiment 3 is different from the human detecting means 10 in accordance with Embodiment 1 but is the same as the human detecting means 28 in accordance with Embodiment 2. In other words, the means is a means of counting coming in a predetermined range around the robot body 170 and going out therefrom as one time.

In Embodiment 3, as a judgment on health, security or safety, processing comprising judgment steps shown in FIG. 8 is carried out to judge whether the user is healthy or secure.

Only the differences from Embodiment 1 are described; the access histories stored in the access history storing means 12 are data obtained by counting coming in a predetermined range around the robot body 170 and going out therefrom as one time. In addition, in the judgment of the present number of times of accesses, one coming-and-going is counted as one time in the counting of the number of times of human detections.

The method of comparing with the threshold value is the same as that of Embodiment 1 in that mutual comparison is carried out with respect to the sum of the number of times of human detections and the number of times of operations.

FIG. 9 shows an example of access history data in accordance with Embodiment 3. A graph 22 is a graph showing the number of times of human detections (the number of times of comings-and-goings) and the number of times of past operations in a normal usage state (average) with respect to time. As in the case of the above-mentioned embodiments, it is assumed that the parameter of time resolution (time width) for judgment is two hours, and that the threshold value for the judgment on health or security is 50%.

Attention is paid to average usage state 23 in the period from 6:00 to 7:59 and average usage state 24 in the period from 18:00 to 19:59 in the data in the past three days. In the period from 6:00 to 7:59, the average number of times of human detections is two and the average number of times of operations is three. Hence, the number of times of accesses is five. Furthermore, the average number of times of human detections is five and the average number of times of operations is 22 according to average usage state 24 in the period from 18:00 to 19:59. Hence, the number of times of accesses is 27.

The number of times of accesses (the sum of the number of times of human detections and the number of times of operations) used at the present time is compared with the average number of times of accesses (the sum of the number of times of human detections and the number of times of operations) for two hours in the past three days using the judging means 14 in the same time resolution of two hours. Herein, the number of times of human detections is one and the number of times of operations is two in usage state 26 in the period from 6:00 to 7:59 in the graph 25 of a judgment notification state. Hence, the number of times of accesses is three. Furthermore, the number of times of human detections is two and the number of times of operations is zero in usage state 27 in the period from 18:00 to 19:59 in the graph 25 of the judgment notification state. Hence, the number of times of accesses is two.

Thus, in the case of the period from 6:00 to 7:59, when (the average number of times of human detections+the average number of times of operations in the past three days) is calculated and compared with the calculated value of (the number of times of human detections+the number of times of operations) of the graph 25 of the security judgment notification state, since the usage (3/5>0.5) larger than the threshold value of 50% is done, it is judged that the person is healthy or secure, and no notice is issued.

In the case of the period from 18:00 to 19:59, the culculation of (the average number of times of human detections+the average number of times of operations in the past three days) shows (2/27<0.5), and it is judged that a condition of being harmful to health or not secure has occurred for some reason.

### Embodiment 4

Although the monitoring system in accordance with Embodiment 4 is the same as Embodiment 2 in configuration, it is different in health judgment and human detection methods; hence, the different points will be described mainly.

As shown in FIG. 10, a human detecting means 10 in accordance with Embodiment 4 is the same as the human detecting means 10 in accordance with Embodiment 1 but different from the human detecting means 28 in accordance with Embodiment 2. In other words, the means is a means of performing count-up at every predetermined time after a person comes in a predetermined range around the robot body 170, as long as the person is detected.

In Embodiment 4, as a judgment on health, security or safety, processing comprising judgment steps shown in FIG. 11 is carried out to judge whether the user is healthy or secure.

Only the differences from Embodiment 1 are described; the human detecting means 10 detects a person at predetermined time intervals and counts the result.

The method of comparing with the threshold value is the same as that of Embodiment 2 in that mutual comparison is carried out with respect to the ratio of the number of times of operations to the number of times of human detections.

FIG. 12 shows an example of access history data in accordance with Embodiment 4.

A graph 30 is a graph showing the number of times of human detections (the number of times of human detections at every predetermined time) and the number of times of past operations in a normal usage state (average) with respect to time. In this embodiment, it is also assumed that the parameter of time resolution (time width) for the judgment is two hours, and that the threshold value for the judgment on health or security is 50%.

Attention is paid to average usage state 31 in the period from 6:00 to 7:59 and average usage state 32 in the period from 18:00 to 19:59 in the graph 30 showing the average usage state. In the period from 6:00 to 7:59, the average number of times of human detections is ten and the average number of times of operations is three. Hence, (the number of times of operations/the number of times of human detections) serving as the degree of access is 3/10=0.3. Furthermore, in the period from 18:00 to 19:59, the average number of times of human detections is 20 and the average number of times of operations is 22. Hence, (the number of times of operations/the number of times of human detections) serving as the degree of access is 12/22=1.1.

Next, the ratio of the number of times of operations to the number of times of human detections used at the present time is compared with the ratio of the average number of times of operations to the average number of times of human detections in the past three days. Herein, the number of times of human detections is nine and the number of times of operations is two in usage state 34 in the period from time 6:00 to time 7:59 in the graph 33 of a judgment notification state. Hence, (the number of times of operations/the number of times of human detections) serving as the degree of access is 2/9=0.222. Furthermore, the number of times of human detections is 15 and the number of times of operations is three in average usage state 35 in the period from 18:00 to 19:59 in the graph 33 of the judgment notification state. Hence, (the number of times of operations/the number of times of human detections) serving as the degree of access is 3/15=0.2.

In this way, (the average number of times of operations in the past three days/the average number of times of human detections in the past three days) is calculated and compared with the calculated value of (the number of times of operations/the number of times of human detections) of the graph 33 of the judgment notification state. As described above, the value is (0.222/0.3>0.5) in average usage state 31 in the period from 6:00 to 7:59; hence, it is judged that the person is healthy or secure, and no notice is issued.

Furthermore, as described above, in the case of the period from 18:00 to 19:59, (0.2/1.1<0.5), and it is thus known that the number of times of operations is less than ever before although the person is detected in the circumference of the robot body 170. Hence, since the behavior of the person in the house is abnormal, it is judged that there is a possibility that the person, who is in the vicinity of the robot body 170, is sick or not secure, for example, the person has sprained his ankle and cannot move.

### Embodiment 5

FIG. 13 is a view showing a pet-type robot serving as an example of a monitoring electronic apparatus system in accordance with Embodiment 5 and a block diagram thereof. The basic configuration of the electronic apparatus system of monitoring health, security or safety in accordance with Embodiment 5 is the same as that of Embodiment 1. Embodiment 5 is different in that it is further provided with a judgment confirming means 18 of carrying out health confirmation from the robot body 170 to a person in the case that it is judged by the judging means 14 that the person is not healthy. Hence, the different points will be described mainly. The same components as those of Embodiment 1 are designated by the same numerals.

The electronic apparatus system of monitoring health, security or safety in accordance with Embodiment 5 is provided with judgment steps shown in FIG. 14 as a judgment method and judges whether the user is healthy. Since judgment steps S30 to S33 in accordance with Embodiment 5 are similar to judgment steps S10 to S13 in accordance with Embodiment 1, description thereof is omitted.

In the case that it is judged that the user is damaged in health or security at step S33, there is a possibility that although the user is in front of the robot body 170, the user is just doing something else and is not using the robot body 170, and that the judgment is misinformation. Hence, voice for the purpose of confirmation, for example, “Are you all right?” is generated from a speaker 200 provided in the robot body 170 by the judgment confirming means 18. In the case that there is no voice response of the user to the voice, there is a possibility that the user may have fainted and collapsed, for example, and it is conceivable that a problem has occurred without doubt.

In the end, at notification step S35, the result of the judgment is notified by the information notifying means 15 to family members and relatives outside the house, a regional welfare center, a security company, etc. using means, such as voice, electronic mail, telephone or wireless communication.

As described above, after the judgment, the result of the judgment is further confirmed, and then notified to the outside while misinformation is minimized; hence, it is possible to ensure health, security or safety at home.

The above-mentioned operation to the robot body 170 in response to the call from the robot body 170 in accordance with the present invention corresponds to a voice response in Embodiment 5, but may be switching operation to the robot body 170 or movement of the robot body 170.

A confirming means of carrying out confirmation by recognizing operation to the robot body 170 in accordance with the present invention corresponds to the judgment confirming means 18 that confirms the result of the judgment on the basis of user's response to the call from the robot body 170 in Embodiment 5.

### Embodiment 6

FIG. 15 is a view showing a pet-type robot serving as an example of a monitoring electronic apparatus system in accordance with Embodiment 6 and a block diagram thereof. The basic configuration of the electronic apparatus system of monitoring health, security or safety in accordance with Embodiment 6 is the same as that of Embodiment 1.

The monitoring electronic apparatus system in accordance with Embodiment 6 is provided with a human detection confirming means 19 of reconfirming human detection and a detection duration time storing means 21 of storing duration time during which human detection is carried out by the human detection confirming means 19 in the case that there is a possibility that a person is not healthy or secure as the result of a judgment on health, security and safety. Furthermore, the system is also provided with a judgment confirming means 20 of carrying out a further judgment on health, security and safety using the human detection duration time stored by the detection duration time storing means 21. Embodiment 6 differs from Embodiment 1 in that it is provided with the human detection confirming means 19, the detection duration time storing means 21 and the judgment confirming means 20. Hence, the different points will be described mainly. The same components as those of Embodiment 1 are designated by the same numerals.

The electronic apparatus system of monitoring health, security or safety in accordance with Embodiment 6 is provided with judgment steps shown in FIG. 16 as a judgment method and judges whether information can be provided securely to the user. Since judgment steps S40 to S43 in accordance with Embodiment 6 are similar to judgment steps S10 to S13 in accordance with Embodiment 1, description thereof is omitted.

In the case that although a person is in front of the robot body 170, the person is just doing something else and is not using the robot body 170, the person does not carry out operation; hence, the number of times of accesses decreases, and a judgment stating that the person is not healthy or secure is made. In this case, there is a possibility that the judgment is misinformation. In other words, in the case that the number of times of accesses, that is, the sum of the number of times of human detections (the number of times of human detections in every predetermined time) and the number of times of operations, is less than the threshold value, it is judged that that the person is not healthy or secure; however, in the case that the number of times of human detections is extremely small, there is a possibility that the person has many things to do and is busy; in this case, it may be possible to judge that the person is healthy or secure. Alternatively, even in the case that the number of times of human detections is regarded as the number of times of comings-and-goings, in the case of frequent comings-and-goings, the above-mentioned (the number of times of operations/the number of times of human detections) may become smaller than the threshold value. However, it may be possible to judge that the person is healthy or secure.

Hence, for the purpose of eliminating misinformation, the duration time during which the person is detected is detected by the human detection confirming means 19 at step S44.

Next, the duration time during which the person is detected by the human detection confirming means 19 is stored in the detection duration time storing means 21. In the case that the person is detected for a long time of a certain time period or more by the judgment confirming means 20 using this detection duration time, there is a possibility that the person may have fainted and collapsed, for example, and it is conceivable that a problem has occurred without doubt.

In the end, at step S45, the result of the judgment is notified by the information notifying means 15 to family members and relatives outside the house, a regional welfare center, a security company, etc. using means, such as voice, electronic mail, telephone or wireless communication.

In the present invention, a judgment confirming means of carrying out confirmation of health, security or safety on the basis of the duration time during which a person is detected corresponds to the judgment confirming means 20 in Embodiment 6.

The human detecting means in accordance with the present invention may be a human detecting means installed in the pet-type robot body 170 itself or disposed in the circumference of the pet-type robot body 170 so as to detect that a person is within a predetermined circumference of several meters; in brief, the means should only be capable of detecting that a person is within a predetermined circumference of the robot body 170.

In addition, a human detecting means formed of a current collecting sensor may be installed at the entrance and/or window of a house, and a judgment on health, security or safety may be made using this human detecting means by judging whether a person is at home or not. By judging whether the person is at home as described above, it is possible to detect that the person has fallen at a place not in the circumference of the robot body 170 or in another room. Furthermore, the pet-type robot may be a human detecting means installed separately on the door or the like of a room in which the pet-type robot body 170 is placed, so as to judge whether a person is in the room.

Still further, in the present invention, the human detecting means of detecting whether a person is present may comprise separate means, that is, a human detecting means of creating access histories and a human detecting means being used as a precondition of operation of making a judgment on health, security or safety (a human detecting means being used as a reference at the time when the judgment is carried out only when the person is in a predetermined circumference range). Moreover, the human detection range may be changed; for example, the human detection range for access history creation may be 3 m around the circumference of the robot body 170, and the human detection range for health judgment may be 5 m around the circumference.

The human detecting means in accordance with the present invention corresponds to the human detecting means 10 and 28 formed of a current collecting sensor; however, the human detecting means may be a human detecting means, such as a touch sensor or a pushbutton switch, capable of outputting detection information detected by making contact with the robot body 170, or the human detecting means may be a human detecting means, such as a microphone or an expiratory flow sensor, capable of outputting detection information detecting that voice has been generated by the user to the robot body 170; in brief, the human detecting means should only be a human detecting means that detects that a person is within a predetermined area and then outputs the signal.

The access detecting means in accordance with the present invention comprises the human detecting means 10 and the operation detecting means 11; however, it may comprise only either the human detecting means or the operation detecting means.

Furthermore, in Embodiments 1 and 2, comparison is carried out with respect to the average values of the number of times of human detections and the number of times of past operations to make a judgment on health, security or safety; however, a CCD camera 29 serving as an example of an image recognizing means in accordance with the present invention may further be provided as shown in FIG. 1 to read the expression of a person, whereby a judgment on the number of times of smiles or the like may be made. In this case, it is possible to make a judgment on mental health. Moreover, a microphone 39 serving as an example of a voice recognizing means in accordance with the present invention may further be provided as shown in FIG. 4, to make a comparison with respect to the pitch of voice or the like, whereby a judgment on health, such as a state of having a cold, may be made.

Instead of detecting a person at every predetermined time and counting the number of times of detections, it may be possible to detect a time period during which a person is present within a predetermined circumference of the robot body 170. For example, it is only necessary to use a method of counting, using a timer, a time period from the time when a person having entered the predetermined range was detected to the time when the person went out.

Although the robot in the monitoring electronic apparatus system in accordance with the embodiments of the present invention is a pet-type robot, it may be an ordinary robot or may be attached to a refrigerator or the like. However, a pet-shaped object, such as a pet-type robot, is preferable. Since such a pet-type robot gives a healing effect to a solitary old person or the like, health monitoring or security monitoring can be carried out while a sense of being monitored is felt far less than that in an ordinary robot.

The program of the present invention is a program that carries out the functions of all or part of the means (or apparatuses, devices, etc.) of the above-mentioned electronic apparatus system of monitoring health, security or safety in accordance with the present invention using a computer and operates in cooperation with the computer.

Still further, the recording medium of the present invention is a recording medium having a program that carries out all or part of the functions of all or part of the means of the above-mentioned electronic apparatus system of monitoring health, security or safety in accordance with the present invention using a computer, the medium is readable using the computer, and the above-mentioned program having been read from the recording medium is used to carry out the above-mentioned functions in cooperation with the above-mentioned computer.

Still further, the above-mentioned “part of the means” of the present invention is one or several means in the multiple means thereof.

Still further, the above-mentioned “the functions of the means” of the present invention are all or part of the functions of the above-mentioned means.

Still further, one utilization form of the program of the present invention may be an embodiment that is recorded on a recording medium readable by a computer and operates in cooperation with the computer.

Still further, another utilization form of the program of the present invention may be an embodiment that is transmitted through a transmission medium, is read by a computer and operates in cooperation with the computer.

Still further, the recording medium includes ROM and the like, and the transmission medium includes a transmission medium, such as the Internet, light, electric wave, sound wave, etc.

Still further, the above-mentioned computer of the present invention is not limited to pure hardware, such as a CPU, but may be firmware, OS and peripheral devices.

Still further, as described above, the configuration of the present invention may be attained by software or by hardware.

### INDUSTRIAL APPLICABILITY

As being clarified by the above descriptions, the present invention can provide an electronic apparatus system of monitoring health, security or safety without causing a sense of being monitored.

1. A monitoring electronic apparatus system comprising:
an electronic apparatus body,
human detecting means of detecting that a person is within a predetermined circumference of said electronic apparatus body and outputting a signal,
access detecting means of detecting access to said electronic apparatus body,
access history storing means of storing an output from said access detecting means,
parameter storing means of storing a parameter that is determined on the basis of said access histories and serves as a reference required for monitoring health, security or safety, and
judging means of making a judgment on health, security or safety by comparing all or part of access histories obtained from said access history storing means after the determination of said parameter, with said parameter obtained from said parameter storing means in a case that the person is detected by said human detecting means within the predetermined circumference of said electronic apparatus body, or not making a judgment on health, security or safety in a case that the person is not detected within the predetermined circumference of said electronic apparatus body.

2. A monitoring electronic apparatus system according to claim 1, wherein said access history includes at least a number of times of human detections by said human detecting means or another human detecting means and a number of times of operations to said electronic apparatus body.

3. A monitoring electronic apparatus system according to claim 1, wherein
said parameter is a parameter determined by a sum of the number of times of human detections and the number of times of operations to said electronic apparatus body in said access histories, and
said judging means making a judgment on health, security or safety by comparing the sum of the number of times of human detections and the number of times of operations to said electronic apparatus body in all or part of access histories obtained from said access history storing means after the determination of said parameter, with said parameter.

4. A monitoring electronic apparatus system according to claim 1, wherein
said parameter is a parameter determined by the ratio of the number of times of operations to said electronic apparatus body to the number of times of human detections in said access histories,
said judging means making a judgment on health, security or safety by comparing the ratio of the number of times of operations to said electronic apparatus body to the number of times of human detections in all or part of access histories obtained from said access history storing means after the determination of said parameter, with said parameter.

5. A monitoring electronic apparatus system according to claim 2, wherein said number of times of human detections is the number of times of detections at every predetermined time.

6. A monitoring electronic apparatus system according to claim 2, wherein said number of times of human detections is the number of times of comings-and-goings within a predetermined circumference of said electronic apparatus body.

7. A monitoring electronic apparatus system according to claim 5, wherein duration time from time of coming in the predetermined circumference of said electronic apparatus body to time of going out therefrom is used instead of said number of times of detections at every predetermined time.

8. A monitoring electronic apparatus system according to claim 1, further comprising judgment confirming means of making a confirmation of health, security or safety by recognizing an operation done by the person to said electronic apparatus body in response to a call from said electronic apparatus body to the person in a case that a judgment stating that the person is not healthy or secure is output by said judging means.

9. A monitoring electronic apparatus system according to claim 1, further comprising:
human detection confirming means of detecting a person in a case that a judgment stating that the person is not healthy or secure is output by said judging means, and
judgment confirming means of confirming health, security or safety on the basis of duration time during which the person is detected by said human detection confirming means.

10. A monitoring electronic apparatus system according to claim 1, wherein said human detecting means is a sensor of detecting whether the person is in a house provided with said electronic apparatus body, and a current collecting sensor installed at an entrance and/or a window thereof.

11. A monitoring electronic apparatus system according to claim 1, wherein said human detecting means is a current collecting sensor installed in said electronic apparatus body.

12. A monitoring electronic apparatus system according to claim 1, further comprising image recognizing means capable of recognizing the expression of the person, wherein said judging means judging whether the person is healthy or secure on the basis of image data information obtained from said image recognizing means.

13. A monitoring electronic apparatus system according to claim 1, further comprising voice recognizing means capable of recognizing the voice of the person, wherein said judging means judging whether the person is healthy or secure on the basis of voice data information obtained from said voice recognizing means.

14. A monitoring electronic apparatus system according to claim 1 being a pet-type robot.

15. A monitoring method comprising:
a human detecting step of detecting that a person is within a predetermined circumference of an electronic apparatus body and outputting a signal,
an access detecting step of detecting access to said electronic apparatus body,
an access history storing step of storing an output from said access detecting step,
a parameter storing step of storing a parameter that is determined on the basis of said access histories and serves as a reference required for monitoring health, security or safety, and
a judging step of making a judgment on health, security or safety by comparing all or part of access histories obtained from said access history storing step after the determination of said parameter, with said parameter obtained from said parameter storing step in a case that the person is detected by said human detecting step within the predetermined circumference of said electronic apparatus body, or not making a judgment on health, security or safety in a case that the person is not detected within the predetermined circumference of said electronic apparatus body.

16. A program of operating a computer to function as:
access history storing means of storing an output from said access detecting means,
parameter storing means of storing a parameter that is determined on the basis of said access histories and serves as a reference required for monitoring health, security or safety, and
judging means of making a judgment on health, security or safety by comparing all or part of access histories obtained from said access history storing means after time of the determination of said parameter, with said parameter obtained from said parameter storing means in a case that the person is detected by said human detecting means within the predetermined circumference of said electronic apparatus body, or not making a judgment on health, security or safety in a case that the person is not detected within the predetermined circumference of said electronic apparatus body in a monitoring electronic apparatus system according to claim 1.

17. A recording medium having said program according to claim 16 and being usable by a computer.
